(19) United States
(12) Patent Application Publication
(10) Pub. No.: US 2014/0085295 A1
(43) Pub. Date: Mar. 27, 2014

(54) DIRECT ENVIRONMENTAL MAPPING METHOD AND SYSTEM

(71) Applicant: Tamaggo Inc., Montreal (CA)

(72) Inventor: Dongxu LI, Pointe-Claire (CA)

(73) Assignee: Tamaggo Inc., Montreal (CA)

(21) Appl. No.: 13/950,410

(22) Filed: Jul. 25, 2013

Related U.S. Application Data
(60) Provisional application No. 61/704,088, filed on Sep. 21, 2012.

(51) Int. Cl. G06T 17/00

(52) U.S. Cl. CPC G06T 17/00
USPC 345/419

(57) ABSTRACT

There is provided a method for mapping a panoramic image to a 3-D virtual object of which a projection is made for display on a screen. The method includes: providing the panoramic image in a memory, the panoramic image being defined by a set of pixels in a 2-dimensional space; providing a model of the object, the model having a set of vertices in a 3-dimensional space; selecting a vertex on the model, the selected vertex being characterized by a set of angular coordinates; applying a transformation to the angular coordinates to obtain a set of polar coordinates; identifying a pixel whose position in the panoramic image is defined by the polar coordinates; and storing in memory an association between the selected vertex on the model and a value of the identified pixel.

### REFERENCE TO RELATED APPLICATIONS

This application is a non-provisional of, and claims priority from, U.S. Provisional Patent Application U.S. 61/704,088 entitled “DIRECT ENVIRONMENTAL MAPPING METHOD AND SYSTEM” filed Sep. 21, 2012 the entirety of which is incorporated herein by reference.

### FIELD

The proposed solution relates to panoramic imaging and in particular to systems and methods for direct environmental mapping.

### BACKGROUND

Environmental mapping by skybox and skydome is widely used in displaying of 360 panorama images. When the panorama is provided in an elliptic form, the image is transformed to 6 cubic images to be shown on the 6 faces of the skybox or, in the case of a skydome, transformed to a single rectangle image with pixels scaled according to azimuth and polar angles of the skydome. The cubic or rectangle images are loaded into a graphics processing unit (GPU) as mesh textures and applied on the skybox or skydome shaped mesh, respectively. The geometrical mapping from elliptic image to cubic images or rectangle image is found to be the slowest, i.e., the speed limiting step in the whole panorama loading process.

### SUMMARY

Certain non-limiting embodiments of the present invention provide a direct mapping algorithm that combines the geometrical mapping and texture applying steps into a single step. To this end, a non-standard skydome can be used, which has its texture coordinates determined according to an elliptic-to-skydome geometrical mapping, instead of using azimuth and polar angles as in an equirectangular to skydome mapping. When a skybox is used, the skybox has texture coordinates according to the elliptic-to-skybox mapping, instead of texture coordinates being linear to pixel locations as in the case of standard cubic mapping provided by 3D GPUs. The texture coordinates are generated for each elliptic panorama based on the camera lens mapping parameters of the elliptic image, and the texture coordinate generation process can be carried out by a CPU or by a GPU using vertex or geometry shaders.

### BRIEF DESCRIPTION OF THE DRAWINGS

The invention will be better understood by way of the following detailed description of embodiments of the invention with reference to the appended drawings, in which:

FIG. 1 is a schematic plot showing a camera radial mapping function in accordance with the proposed solution;

FIG. 2A is an illustration of a dome view in accordance with the proposed solution;

FIG. 2B is a comparison between illustrations of (a) a cubic mapping and (b) a direct mapping in accordance with the proposed solution;

FIG. 2C is a comparison between (a) a cubic mapping process and (b) a direct mapping process in accordance with the proposed solution;

FIG. 3 is a schematic diagram illustrating relationships between spaces;

FIG. 4(a) is a schematic diagram illustrating rendering a view of a texture surface on a screen in accordance with the proposed solution;

FIG. 4(b) is a schematic diagram illustrating a 2-D geometric mapping of a textured surface in accordance with the proposed solution;

FIG. 5 is a schematic diagram illustrating direct mapping from an elliptic image to skydome as defined by Eq. (2.1) in accordance with the proposed solution;

FIG. 6 is an algorithmic listing illustrating dome vertex generation in accordance with a non-limiting example of the proposed solution; and

FIG. 7 is an algorithmic listing illustrating cube/box vertex generation in accordance with another non-limiting example of the proposed solution,

wherein similar features bear similar labels throughout the drawings.

### DETAILED DESCRIPTION

To discuss texture mapping, several coordinate systems can be defined. Texture space is the 2-D space of surface textures and object space is the 3-D coordinate system in which 3-D geometry such as polygons and patches are defined. Typically, a polygon is defined by listing the object space coordinates of each of its vertices. For the classic form of texture mapping, texture coordinates (u, v) are assigned to each vertex. World space is a global coordinate system that is related to each object's local object space using 3-D modeling transformations (translations, rotations, and scales). 3-D screen space is the 3-D coordinate system of the display, a perspective space with pixel coordinates (x, y) and depth z (used for z-buffering). It is related to world space by the camera parameters (position, orientation, and field of view). Finally, 2-D screen space is the 2-D subset of 3-D screen space without z. Use of the phrase “screen space” by itself can mean 2-D screen space.

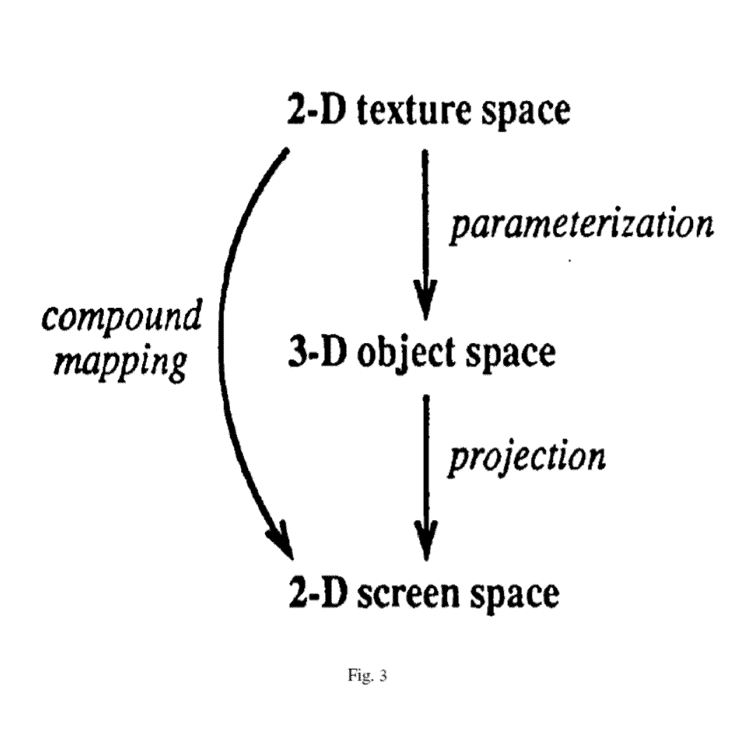

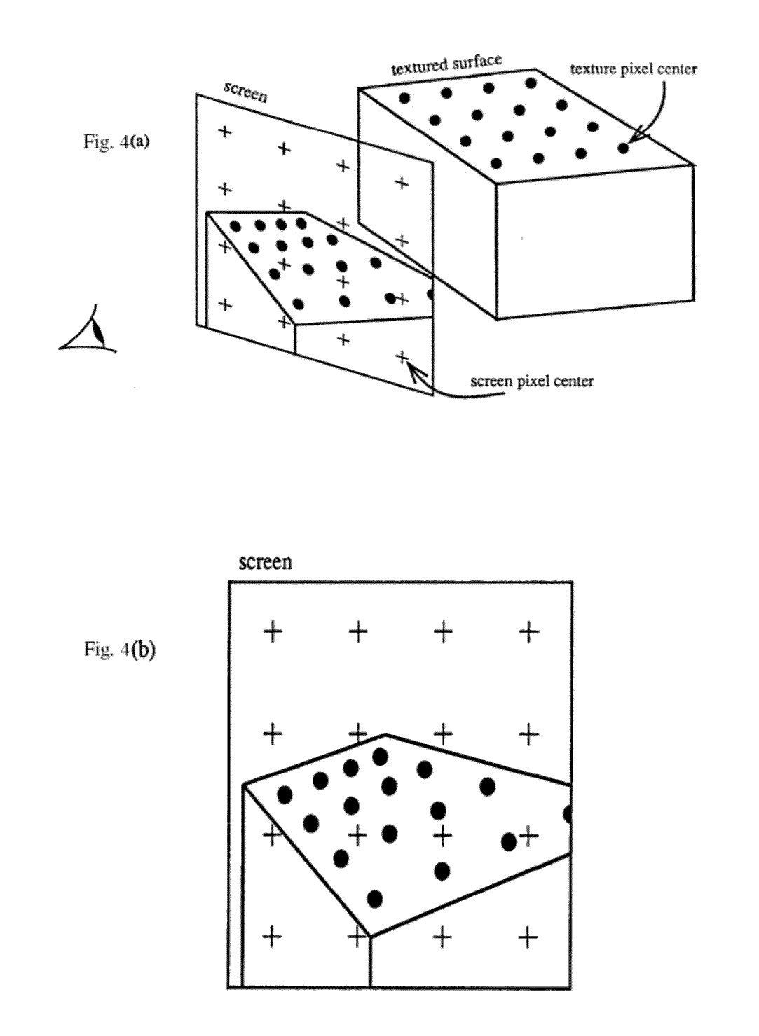

The correspondence between 2-D texture space and 3-D object space is called the parameterization of the surface, and the mapping from 3-D object space to 2-D screen space is the projection defined by the camera and the modeling transformations (FIG. 3). Note that when rendering a particular view of a textured surface (see FIG. 4(a)), it is the compound mapping from 2-D texture space to 2-D screen space that is of interest. For resampling purposes, once the 2-D to 2-D compound mapping is known, the intermediate 3-D space can be ignored. The compound mapping in texture mapping is an example of an image warp, the resampling of a source image to produce a destination image according to a 2-D geometric mapping (see FIG. 4(b)).

In what follows, a skydome and a skybox with texture coordinates set to allow direct mapping are given in detail. However, the algorithm described here is general and can be applied to generate other geometry shapes for panorama viewers.

### Geometry of 3-D Model (Dome)

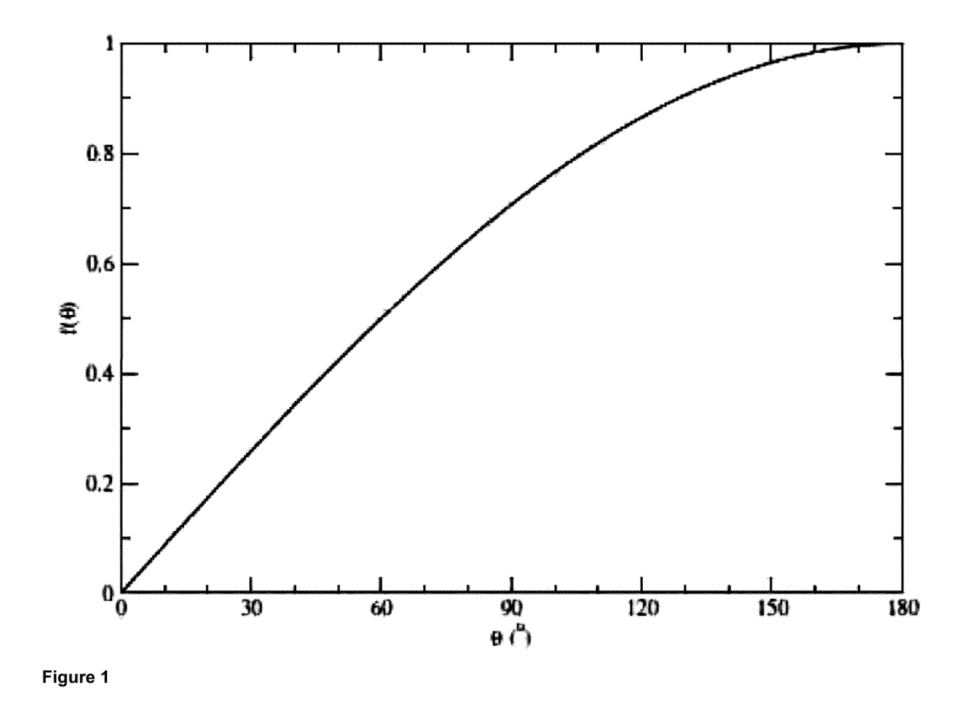

A vertex on a skydome mesh which is centered at the coordinate origin can be located by its angular part in spherical coordinates, (θ,φ), with θ and φ the polar and azimuth angles respectively. The direct mapping from an elliptic image to skydome is defined by

$$\{ \begin{matrix}{r}_{E} = f ( θ ) \\ {θ}_{E} = ϕ\end{matrix} \qquad ( 2.1 )$$

where r_{E} and θ_{E} are the polar coordinates of mapped location within a centered circular or elliptic image, and f(θ) is a mapping function defined by the camera lens projection. The radial mapping function f(θ) is supplied by the camera in a form of a one-dimensional lookup table. See example radial mapping function in FIG. 1.

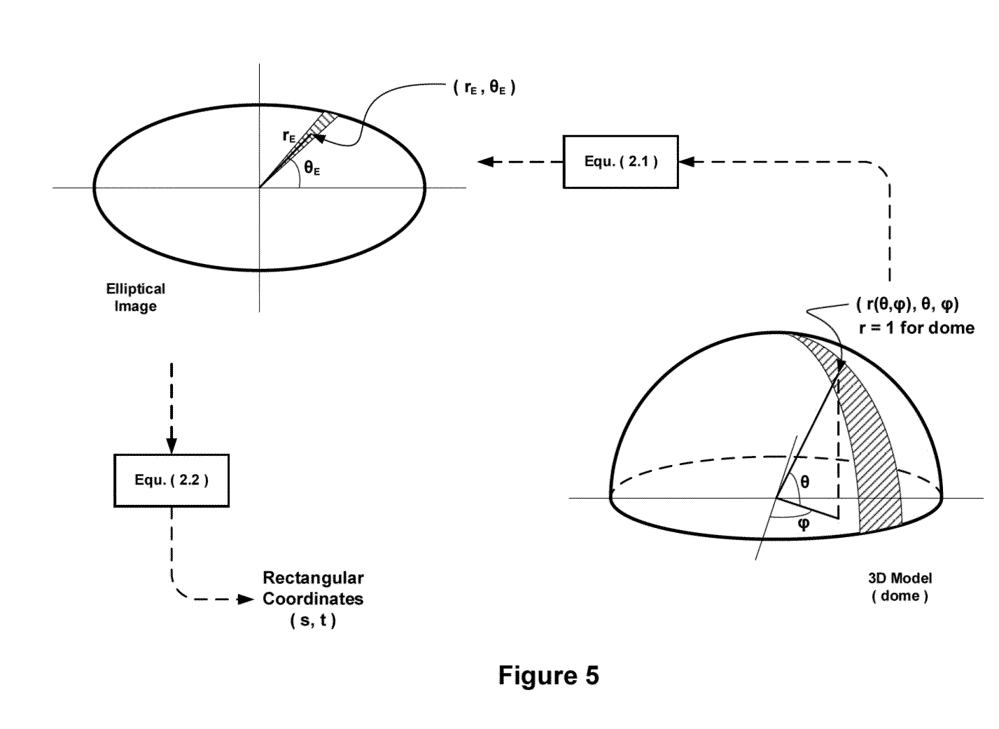

The mapping defined by Eq. (2.1) is conceptually illustrated in FIG. 5.

Note that Eq. (2.1) can be applied to 360-degree fisheye lens images, i.e., where the ellipse is in fact a circle. In that case, the radial mapping function may be a straight line.

The texture coordinates of the vertex is obtained by transforming the polar coordinates into cartesian as follows:

$$\{ \begin{matrix}s = \frac{1}{2} + {r}_{E} cos {θ}_{E} \\ t = \frac{1}{2} + {r}_{E} sin {θ}_{E}\end{matrix} \qquad ( 2.2 )$$

As such, the dome (an example of a 3-D model) is created by generating vertices on a sphere, and the texture coordinates are assigned to the vertices according to Eqs. (2.1) and (2.2).

Once the textures of the vertices of the 3-D model (in this case a sphere, or dome) are known, this results in a 3-D object which can now undergo a projection from 3-D object space to 2-D screen space in accordance with the “camera” angle and the modeling transformation (e.g., perspective projection). This can be done by viewing software.

### Geometry of 3-D Model (Box/Cube)

In a variant, a skybox is used instead of the skydome as the 3-D model. In this case, the vertex locations on the skybox have the form (r(θ,φ),θ,φ) in spherical coordinates, with the radius being a function of angular direction (i.e., defined θ and φ) instead of a constant as in the skydome case. In other words, at a given point on the surface of the mesh shape, the radius has a function that is constrained by θ and φ. This is the case with a cube, for example, although the same will also be true of other regular polyhedrons. Since Eq. (2.1) does not use the radial part, the vertex coordinates are generated by Eqs. (2.1) and (2.2) using the angular part of the vertex coordinates.

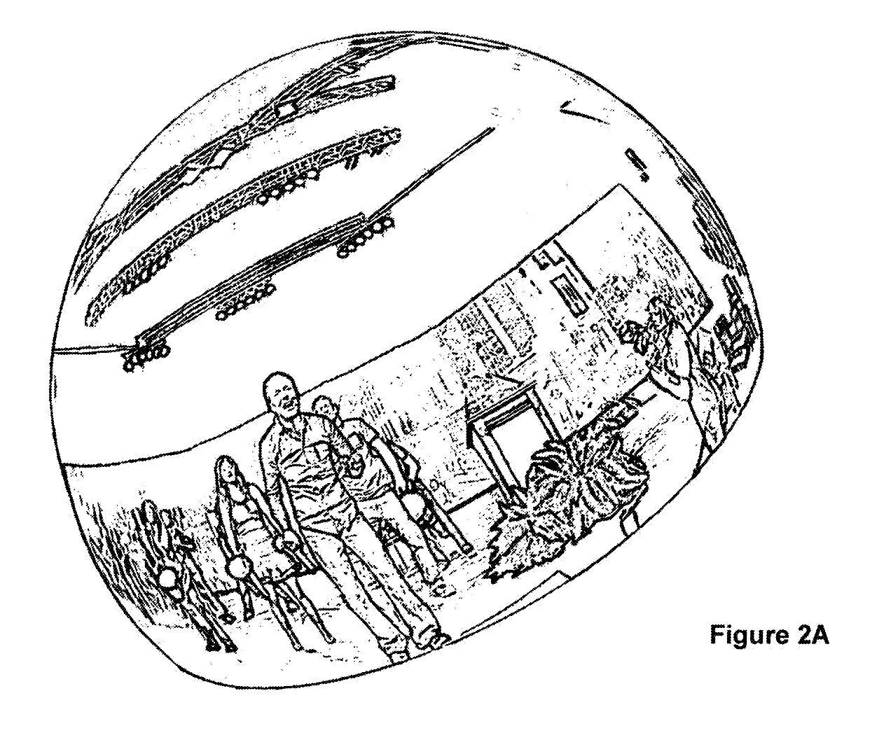

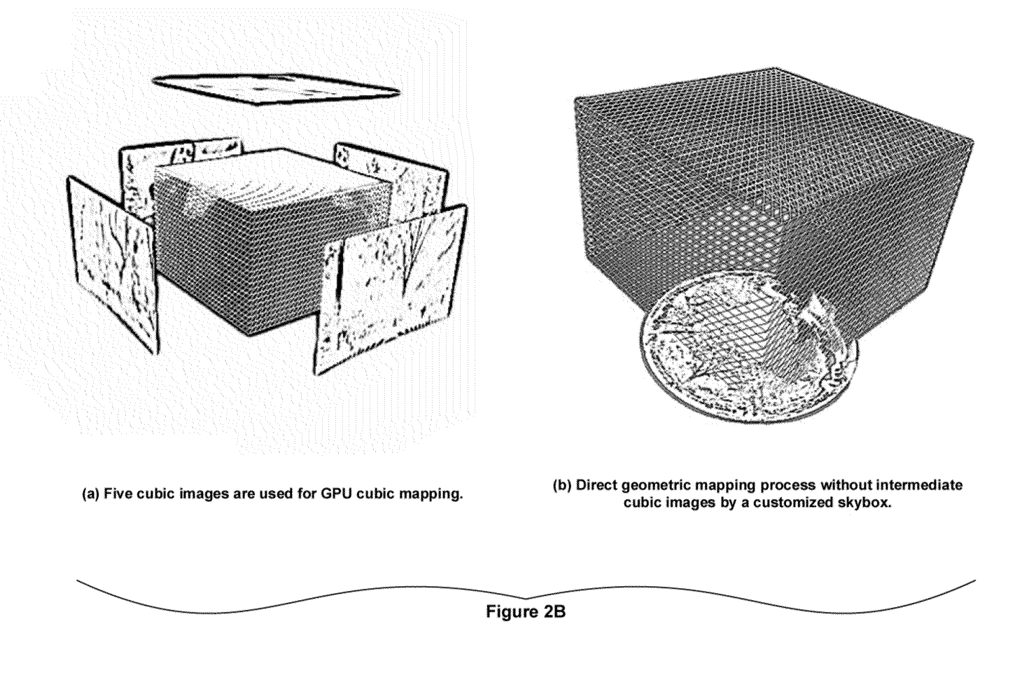

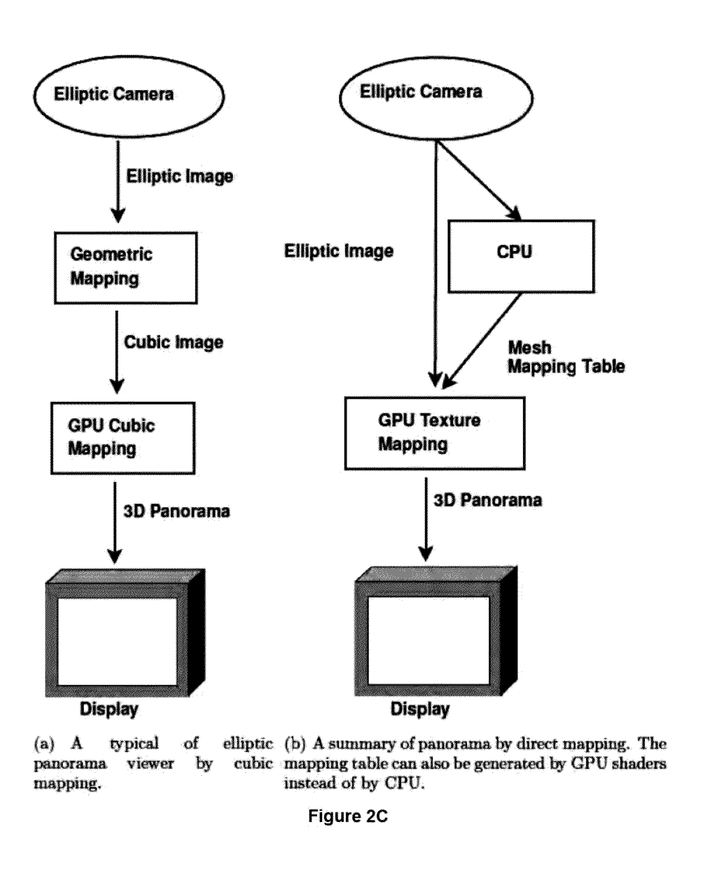

It is seen that the direct mapping (which is implemented by certain embodiments of the present invention) avoids the need for a geometric mapping to transform an input 2-D elliptical image into an intermediate rectangular (for a dome model) or cubic (for a cube/box mode)) image before mapping the intermediate image to the vertices of the 3-D model. Specifically, in the case of direct mapping, the texture for a desired vertex can be found by transforming the 3-D coordinates of the texture into 2-D coordinates of the original elliptic image and then looking up the color value of the original elliptic image at those 2-D coordinates. Conveniently, the transformation can be effected using a vertex shader by applying a simply geometry according to Eq (2.1). On the other hand, when conventional cubic mapping is used, the texture of a desired vertex is found by consulting the corresponding 2-D coordinate of the unwrapped cube. However, this requires the original elliptic image to have been geometrically transformed into the of the unwrapped cube, which can take a substantial amount of time. A comparison of the direct mapping to the traditional “cubic mapping” is shown in FIGS. 2B and 2C.

### General Mesh Shapes

Because the form of (r(θ,φ),θ,φ) is the general case where the function r(θ) specifies the particular mesh shape, Eqs. (2.1) and (2.2) are applicable in generating any geometry where the radius is uniquely determined by the angular position relative to the coordinate origin.

### Implementation

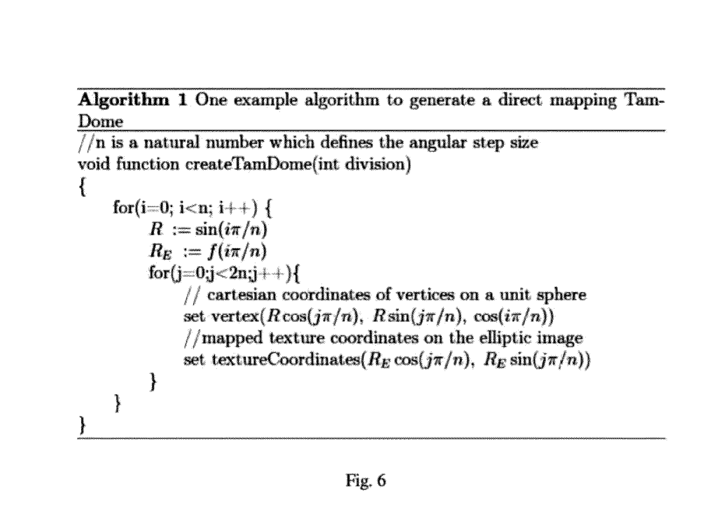

A non-limiting example of dome vertex generation is given by Algorithm 1 in FIG. 6.

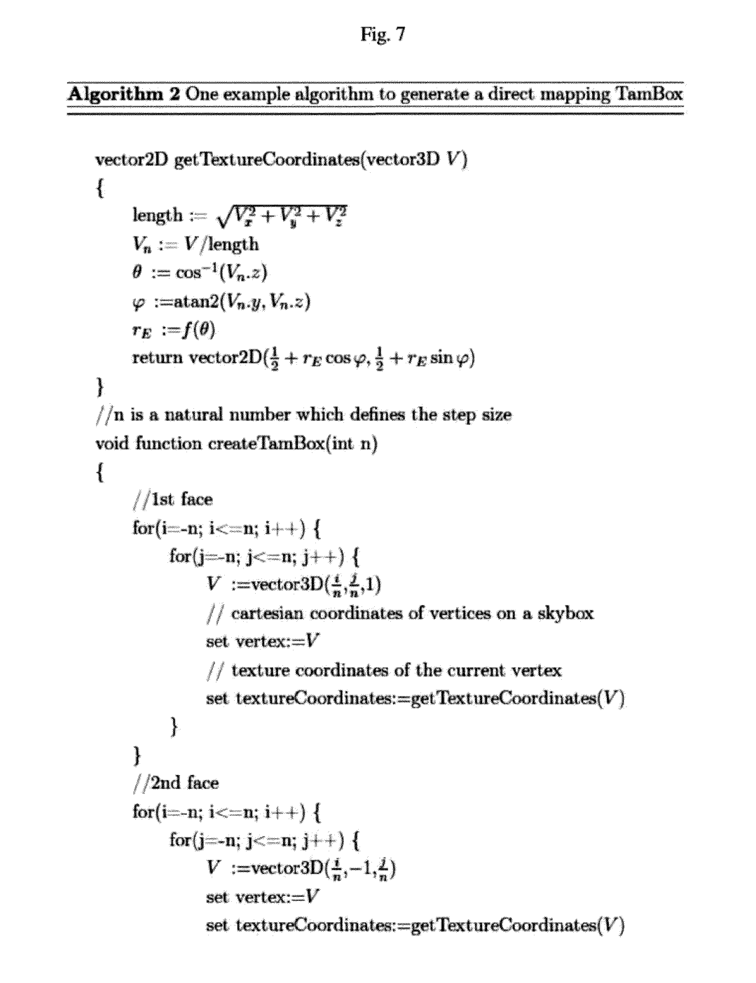

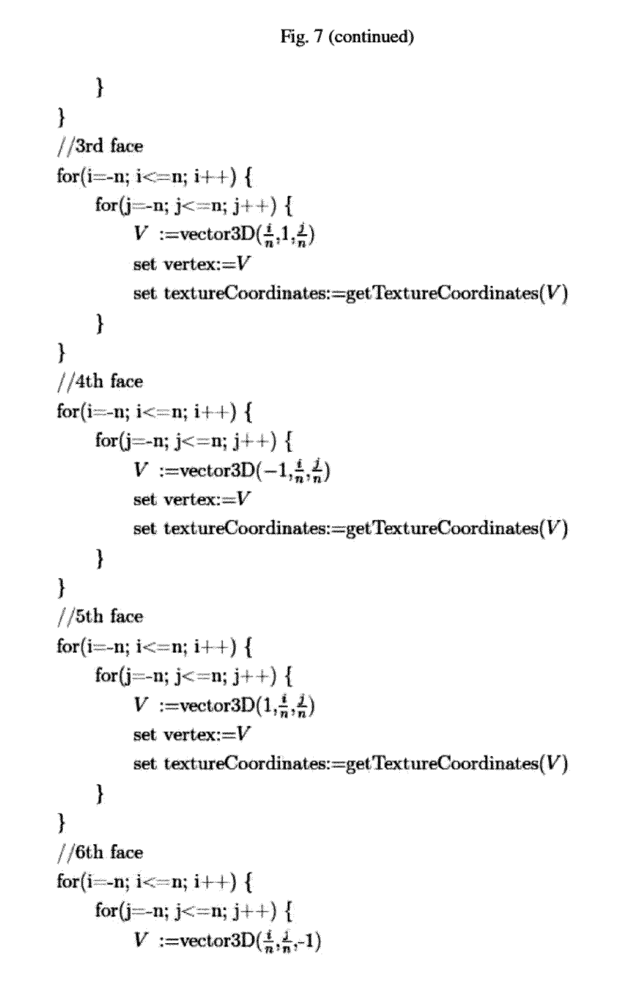

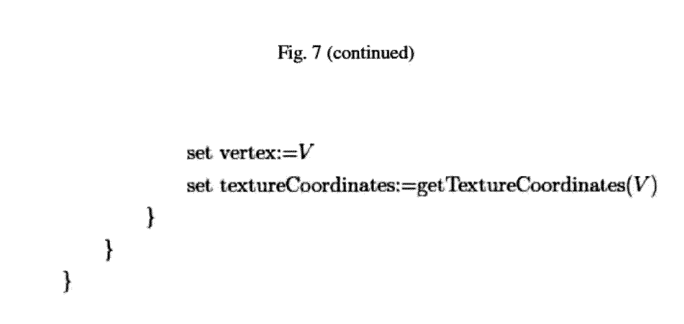

A non-limiting example of cube/box vertex generation is given by Algorithm 2 in FIG. 7.

Those skilled in the art will appreciate that a computing device may implement the methods and processes of certain embodiments of the present invention by executing instructions read from a storage medium. In some embodiments, the storage medium may be implemented as a ROM, a CD, Hard Disk, USB, etc. connected directly to (or integrated with) the computing device. In other embodiments, the storage medium may be located elsewhere and accessed by the computing device via a data network such as the Internet. Where the computing device accesses the Internet, the physical interconnectivity of the computing device in order to gain access to the Internet is not material, and can be achieved via a variety of mechanisms, such as wireline, wireless (cellular, Wi-Fi, Bluetooth, WiMax), fiber optic, free-space optical, infrared, etc. The computing device itself can take on just about any form, including a desktop computer, a laptop, a tablet, a smartphone (e.g., Blackberry, iPhone, etc.), a TV set, etc.

Moreover, persons skilled in the art will appreciate that in some cases, the panoramic image being processed may be an original panoramic image, while in other cases it may be an image derived from an original panoramic image, such as a thumbnail or preview image.

Certain adaptations and modifications of the described embodiments can be made. Therefore, the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

What is claimed is:

1. A method for mapping a panoramic image to a 3-D virtual object of which a projection is made for display on a screen, comprising:
providing the panoramic image in a memory, the panoramic image defined by a set of picture elements (pixels) in a 2-dimensional space;
providing a model of the object, the model comprising a set of vertices in a 3-dimensional space;
selecting a vertex on the model, the selected vertex characterized by a set of angular coordinates;
applying a transformation to the angular coordinates to obtain a set of polar coordinates;
identifying a pixel whose position in the panoramic image is defined by the polar coordinates;
storing in memory an association between the selected vertex on the model and a value of the identified pixel.

2. The method defined in claim 1, wherein the selected vertex on the model is further characterized by a radial component that is constant over a range of vertices on the model.

3. The method defined in claim 1, wherein the selected vertex on the model is further characterized by a radial component that is constant for all vertices on the model.

4. The method defined in claim 1, wherein the selected vertex on the model is further characterized by a radial component that is a function of at least one of the angular coordinates.

5. The method defined in claim 1, wherein the selected vertex on the model is further characterized by a radial component that is not independent of the angular coordinates.

6. The method defined in claim 1, further comprising repeating the selecting, identifying and storing for a plurality of vertices on the model.

7. The method defined in claim 1, wherein the transformation is a function of optical properties of an image acquisition device used to capture the panoramic image.

8. The method defined in claim 1, wherein said association defines a surface pixel for the 3-D object.

9. The method defined in claim 1, wherein the angular coordinates include an azimuth coordinate and a polar coordinate.

10. The method defined in claim 1, further comprising: determining a desired viewing orientation in 3-D space; identifying a viewing window corresponding to the desired viewing orientation, the viewing window occupying a plane in 3-dimensional space; projecting the model onto the viewing window in order to determine a set of surface pixel of the 3-D virtual object that are visible in the desired viewing orientation.

11. The method defined in claim 1, wherein the panoramic image is a 360-degree image and wherein the set of pixels of the panoramic images defines an ellipse.

12. The method defined in claim 1, wherein the 3-D model is a dome.

13. The method defined in claim 1, wherein the 3-D model is a box.

14. A non-transitory computer-readable medium comprising instructions which, when executed by a computer, cause the computer to carry out a method for mapping a panoramic image to a 3-D virtual object of which a projection is made for display on a screen, the method comprising:
providing the panoramic image in a memory, the panoramic image defined by a set of picture elements (pixels) in a 2-dimensional space;
providing a model of the object, the model comprising a set of vertices in a 3-dimensional space;
selecting a vertex on the model, the selected vertex characterized by a set of angular coordinates;
applying a transformation to the angular coordinates to obtain a set of polar coordinates;
identifying a pixel whose position in the panoramic image is defined by the polar coordinates;
storing in memory an association between the selected vertex on the model and a value of the identified pixel.

15. A method of assigning a value to a vertex of an object of interest, comprising:
obtaining 3-D coordinates of the vertex;
using a shader to derive 2-D coordinates based on the 3-D coordinates; and
consulting a panoramic image to obtain a value corresponding to the 2-D coordinates.

16. The method defined in claim 15, wherein the panoramic image is an elliptical image.

17. The method defined in claim 15, wherein the shader is a vertex shader.

18. The method defined in claim 15, wherein the shader utilizes the following geometry in deriving the 2-D coordinates based on the 3-D coordinates:
$$\{ \begin{matrix}{r}_{E} = f ( θ ) \\ {θ}_{E} = ϕ .\end{matrix} \qquad ( 2.1 )$$
